(19) United States
(12) Patent Application Publication
(10) Pub. No.: US 2024/0279968 A1
(43) Pub. Date: Aug. 22, 2024

(54) VEHICLE OPENING ELEMENT HANDLE ASSEMBLY

(71) Applicant: MINEBEA ACCESSSOLUTIONS FRANCE, Alfortville (FR)

(72) Inventors: Christophe PERRIN, Alfortville (FR); Thomas LANNO, Alfortville (FR); Thomas DEVERNOIS, Alfortville (FR); Massimo FRATTINI, Alfortville (FR)

(73) Assignee: MINEBEA ACCESSSOLUTIONS FRANCE, Alfortville (FR)

(21) Appl. No.: 18/571,851

(22) PCT Filed: Jun. 16, 2022
(86) PCT No.: PCT/EP2022/066468

§ 371 Date: Dec. 19, 2023

(30) Foreign Application Priority Data
Jun. 24, 2021 (EP) 21315110.3

(51) Int. Cl. E05B 81/90; E05B 79/20; E05B 81/76; E05B 85/10

(52) U.S. Cl. CPC E05B 81/90; E05B 79/20; E05B 81/76; E05B 85/103

(57) ABSTRACT

A vehicle handle assembly includes a housing that sits flush against an outer panel of the vehicle and defining a cavity inside an opening element, an actuation switch generating an electrical vsignal to be sent to a vehicle opening element controller to release the vehicle opening element, an emergency opening device accessible from the inside of the cavity, the emergency opening device being configured to release mechanically the opening element allowing to open the opening element.

The invention relates to an opening element handle assembly to control the opening of a vehicle element such as a lateral door or a rear door opening, in particular in the case of automated opening element latches that are controlled via electric means without mechanically actuated lever or knob.

Automated opening element latches, such as door latches, selectively lock or unlock vehicle door panels in an automated fashion. By automated door latches are herein designated door latches where the user does not provide the energy to actuate the latch through grasping and moving a handle lever, knob or other.

Once the vehicle panel is released, the user or an electric panel actuator swings or slides the panel to grant physical access the vehicle. Automated door latches, under normal circumstances, do not require bulging handle levers on the exterior surface of the vehicle. The air drag of the vehicle can consequently be reduced, while the visual aspect of the vehicle can be streamlined.

Most automated door latches comprise an electric actuator that sets a bolt, hook or lever in motion upon reception of an actuation signal so as to release the vehicle door. Such an electric actuator can be activated using an electrical or a mechanical switch. The electrical switch has the advantage, compared to a mechanical switch, of saving space in the door assembly as it there is no need to provide room required by the stroke of a mechanical part to be displaced.

However, and by using an opening of vehicle doors by electrical means, a potential issue could be caused by an electrical shutdown of the vehicle, for example following a crash of the vehicle or any other electrical failure, it could not be possible to open a door using electrical means anymore. Furthermore, the integration of mechanisms allowing a mechanical release of the opening element leads to an aesthetic defect of the handle assembly.

The purpose of the invention is therefore to provide an automated vehicle opening element handle assembly that can be opened even when there is an electrical shutdown of the vehicle, the handle assembly without giving up the aesthetic aspect of the handle assembly.

To that end, the invention concerns a vehicle handle assembly comprising:
a housing that sits flush against an outer panel of the vehicle and defining a cavity inside an opening element of the vehicle,
an actuation switch generating an electrical signal to be sent to a vehicle opening element controller to release the vehicle opening element,
The handle assembly also comprises an emergency opening device (26) accessible from the inside of the cavity, the emergency opening device (26) being configured to release mechanically the opening element allowing to open the opening element.

Thanks to the incorporation of an emergency opening device which can open mechanically the opening element, any opening element, for example a door, can be opened in every circumstance, even when the electrical opening is unavailable.

Furthermore, the emergency opening device is accessible in the housing in order to obtain an assembly as compact as possible and preserving the aesthetic aspect of the vehicle.

Preferably, the emergency opening device comprises a gripping member linked to a cable, the cable being connected to an opening element latch mechanism, causing mechanical actuation of the opening element latch mechanism. It allows to obtain a very simple mechanism to release manually the opening element.

The gripping member can be accessible by a through opening made in the housing. Consequently, the housing is not crowded by the emergency opening device when a manual opening is not needed.

Preferably, a removable button is located into the through opening, the gripping member being accessible by pushing the button.

The gripping member can be, in a resting position, placed into a cylinder forming the button. It also allows to obtain a very simple mechanism to release manually the opening element. Furthermore, and as explained below, this system can be reversible.

The emergency opening device can be clipped on a bracket the opening element handle assembly. This is a simple and reversible way to attach the emergency opening device on the handle assembly.

The actuation switch can be a mechanical or an electrical actuation switch.

The actuation switch can comprise at least one reinforcement bar. This allows to protect the actuation switch against any excessive activation effort.

Furthermore, the actuation switch can comprise an NFC reader and/or a RFID reader.

The handle assembly can be a door handle.

### BRIEF DESCRIPTION OF THE FIGURES

The invention will be better understood in view of the following description, referring to the annexed Figures in which:

FIG. 1 is a front view of a part of a vehicle handle assembly according to the invention,

FIG. 2 is a front view of the part of the handle assembly of FIG. 1, without an opening element panel,

FIG. 3 is a view in perspective of the part of the handle assembly of FIG. 2,

FIG. 4 is a front view of the part of the handle assembly of FIG. 2 from the other side of the handle assembly,

FIG. 5 is a view in perspective of the emergency opening device used in the invention,

FIG. 6 is a view in perspective of a part of a vehicle handle assembly according to the invention wherein the emergency opening device is about to be used.

### DETAILED DESCRIPTION

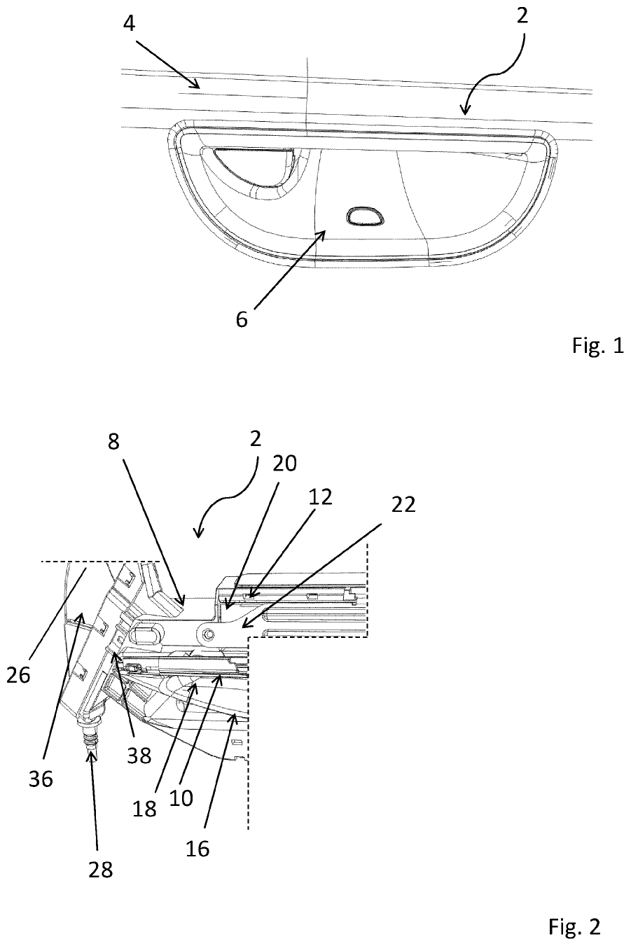

A vehicle handle assembly 2 for a vehicle opening element, for example for a door assembly, is shown on FIG. 1.

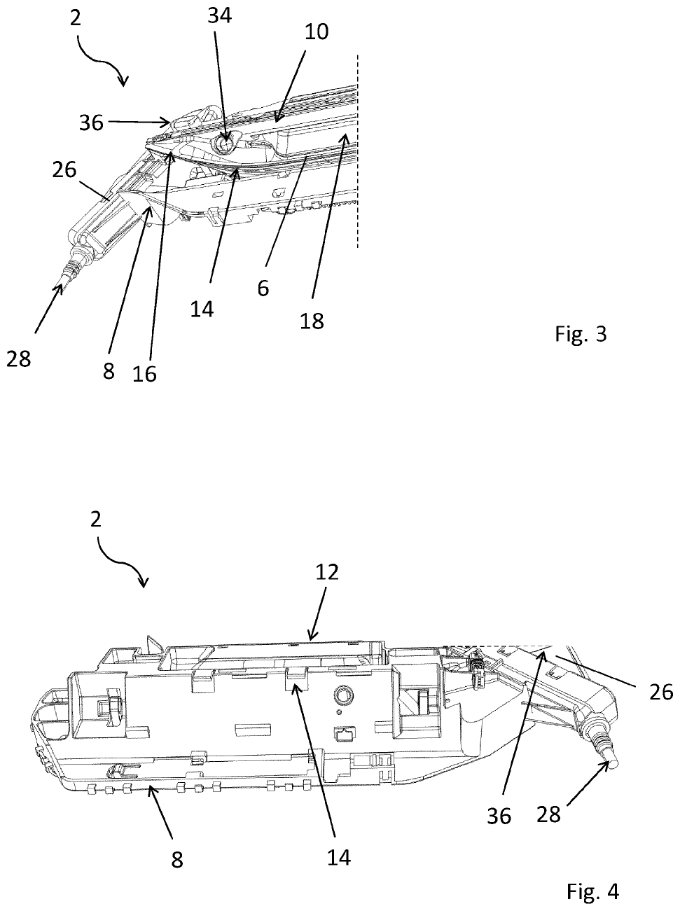

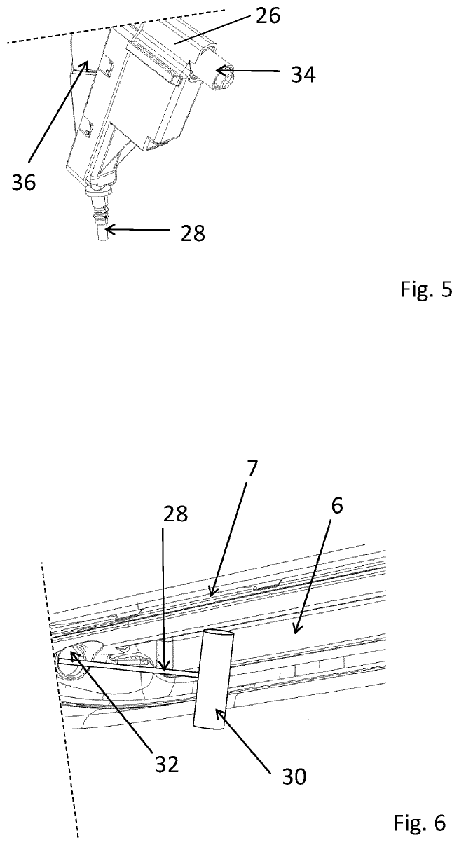

The handle assembly 2 comprises a panel 4 placed and compressed between a housing 6 and a bracket 8 (visible on FIGS. 2 to 4). A gasket 10 is compressed between the edges of the housing 6 and the panel 4 in order to allow a sealing between those two elements. A trim element 7 can be placed at the junction of the panel 4 and the housing 6. This construction leads to the placement of the handle assembly 2 on each sides of the panel 4.

The housing 6 comprises an upper casing 12 and a bowl-shaped reception surface 14 delimiting a cavity giving access to the inside of the upper casing 12. Here, reception surface 14 is delimited by a frame having a rectilinear section, the two extremities of which are joined by a U-shaped section. The housing 6 comprises a front wall 16 which is substantially planar and flush against the panel 4 and a back wall 18 which defines the back of the cavity.

A user can introduce his hand into the cavity in order to interact with an actuation switch 20 generating an electrical signal to be sent to a vehicle opening element controller to release the vehicle opening element. This actuation switch 20 can be electrical or mechanical. The electrical switch has the advantage, compared to a mechanical switch, of saving space in the door assembly as it there is no need to provide room required by the stroke of a mechanical part to be displaced (this space is needed with a mechanical switch wherein a flap is displaced to generate the electrical signal).

Actuation switch is known by skilled persons and will not be described more in this herein after.

The electrical signal generated is able to displace the opening element latch. The actuation switch 20 can also be equipped with NFC and/or RFID readers. Furthermore, the actuation switch 20 can be attached on the bracket 8 (preferably in front of the back wall 18 to allow a user to put his fingers on it) and can be equipped with at least one reinforcement bar 22 to protect the actuation switch 20 against an excessive actuation effort.

The housing 6 and the bracket 8 can be attached to one another using a sliding attachment unit (not shown). This unit crosses the bracket 8 and the panel 4 (which is placed between the bracket 8 and the housing 6) to interact with the housing 6 via hooks introduced into holes carried by the housing 6, and allows a compression of the assembly bracket 8/panel 4/gasket 10/housing 6. More precisely, and when the sliding attachment unit has crossed the bracket 8 and the panel 4, this assembly can slide relative to the housing in order to allow an entrance of the hooks into the holes.

The handle assembly 2 comprises emergency opening device 26 accessible from the inside of the cavity, the emergency opening being configured to open mechanically the opening element.

The emergency opening device 26 allows, in case of electrical shutdown of the vehicle, to open the opening element, for example a door, via a full mechanical way. To do this, a cable 28 is linked to the opening element latch and allow a movement of the latch (and a release of the opening element) in tensioning the cable 28.

In order to tensioning the cable 28, the emergency opening device 26 can comprise a gripping member 30 linked to the cable 28. A user can pull on the gripping member 30, causing mechanical actuation of the opening element latch mechanism.

The emergency opening device 26 can be accessible via a through opening 32 made in housing 6. Thus, the through opening 32 is accessible in the cavity. This allows to keep an optimal aesthetic aspect of the handle assembly 2 integrating the emergency opening device 26.

The gripping member 30 is, in a rest position, out of the cavity. Indeed, only a button 34 is visible into the cavity (it is placed in order to be easily accessible for a user). In this configuration, the gripping member 30 extends into a main body 36 of the emergency opening device 26.

If a manual opening is required, a user can push the button in order to release the gripping member 30 which extends into the cavity.

The button 34 can be formed by the head of the gripping member 30. Alternatively, the gripping member 30 can be placed into a hollow cylinder forming the button 34.

The operation of this kind of emergency opening device 26 is well known by a skilled person and will not be described in this application.

The emergency opening device 26 can be attach to the bracket 8 via clipping means 38 or other reversible attachment means. Alternatively, it can be attach in an irreversible way.

The emergency opening device 26 can be attached in a longitudinal direction of the handle assembly 2. It allows to obtain a very compact system in the thickness of the opening element in which the handle assembly 2 is mounted.

### LIST OF REFERENCES

2: handle assembly
4: panel
6: housing
7: trim element
8: bracket
10: gasket
12: upper casing
14: reception surface
16: front wall
18: back wall
20: actuation switch
22: reinforcing bar
26: emergency opening device
28: cable
30: gripping member
32: through opening
34: button
36: main body
38: clipping means

1. A vehicle handle assembly comprising:
a housing that sits flush against an outer panel of the vehicle and defining a cavity inside an opening element of the vehicle,
an actuation switch generating an electrical signal to be sent to a vehicle opening element controller to release the vehicle opening element, and
an emergency opening device accessible from the inside of the cavity, the emergency opening device being configured to release mechanically the opening element allowing to open the opening element.

2. The vehicle handle assembly according to claim 1, wherein the emergency opening device comprises a gripping member linked to a cable, the cable being connected to an opening element latch mechanism, causing mechanical actuation of the opening element latch mechanism.

3. The vehicle handle assembly according to claim 2, wherein the gripping member is accessible by a through opening made in the housing.

4. The vehicle handle assembly according to claim 3, wherein a removable button is located into the through opening, the gripping member being accessible by pushing the button.

5. The vehicle handle assembly according to claim 4, wherein the gripping member is, in a resting position, placed into a cylinder forming the button.

6. The vehicle handle assembly according to claim 1, wherein the emergency opening device is clipped on a bracket the handle assembly.

7. The vehicle handle assembly according to claim 1, wherein the actuation switch is a mechanical or an electrical actuation switch.

8. The vehicle handle assembly according to claim 1, wherein the actuation switch comprises at least one reinforcement bar.

9. The vehicle handle assembly according to claim 1, wherein the actuation switch comprises an NFC reader and/or a RFID reader.

10. The vehicle handle assembly according to claim 1, wherein the handle assembly is a door handle.
